(19) United States
(12) Patent Application Publication
(10) Pub. No.: US 2025/0298688 A1
(43) Pub. Date: Sep. 25, 2025

(54) REAL-TIME DETECTION, PREDICTION, AND REMEDIATION OF SENSOR FAULTS THROUGH DATA-DRIVEN APPROACHES

(71) Applicant: HITACHI VANTARA LLC, Santa Clara, CA (US)

(72) Inventors: Yongqiang ZHANG, Lexington, MA (US); Wei LIN, Plainsboro, NJ (US)

(21) Appl. No.: 18/861,516

(22) PCT Filed: Apr. 29, 2022
(86) PCT No.: PCT/US2022/027011

§ 371 Date: Oct. 29, 2024

(51) Int. Cl. G06F 11/07

(52) U.S. Cl. CPC G06F 11/0793; G06F 11/0736

(57) ABSTRACT

A method for real-time detection, prediction, and remediation of sensor faults may include receiving sensor data from a plurality of related sensors. The method may also include identifying, for a first sensor in the plurality of related sensors, a set of correlated sensors in the plurality of related sensors. The method may further include detecting a fault in the first sensor based on at least one of the sensor data received from the first sensor, the sensor data received from the set of correlated sensors, and the sensor data received from other sensors. The method may further include implementing a remediation strategy based on the predicted fault of the sensor.

### FIELD

The present disclosure is generally directed to Internet of Things (IoT) and Operational Technology (OT) domains.

### RELATED ART

IoT and OT offer great potential to change the way in which systems function and businesses operate by efficiently monitoring and automating the systems without the need for human interaction or involvement. IoT and OT systems, in some applications, rely on massive amounts of data collected by one or more sensors to automate system operation and decision making. Sensors, in some aspects, may be devices that respond to inputs from the physical world, capture the inputs, and transmit them into the storage device.

Sensors, as used herein, are devices designed to respond to and/or monitor specific types of conditions in the physical world, and then generate a signal (usually electrical) that can represent the magnitude of the condition being monitored. As the application of IoT devices and OT expands, data of different types for analysis and processing, by using different types of sensors. In some aspects, the sensors may include one or more of any of temperature sensors, pressure sensors, vibration sensors, acoustic sensors, motion sensors, level sensors, image sensors, proximity sensors, water quality sensors, chemical sensors, gas sensors, smoke sensors, infrared (IR) sensors, acceleration sensors, gyroscopic sensors, humidity sensors, optical sensors, and/or light detection and ranging (LIDAR) sensors.

The collected sensor data from different types of sensors may be represented differently. For example, some sensors may be analog sensors which attempt to capture continuous values and identify every nuance of what is being measured; or digital sensors which may use sampling to encode what is being measured. As a result, the captured data can either be “analog data” or “digital data”. Accordingly, the data may be numerical values, images, or videos. Additionally, some sensors collect data in streaming manner and use time series data to represent the collected values. Other sensors may collect data in isolated time points.

The IoT and OT Industrial systems, in some aspects, rely on the functioning sensors to monitor the systems and collect accurate data for processing, analysis, and modeling in a set of downstream applications. The data quality from the sensors, in some aspects, plays a fundamental role in IoT and OT domains. Due to the nature of the deployment (which could be in-the-wild and/or in harsh environments) and the limitations of low-cost components, sensors may be prone to failures. In some aspects, a significant fraction of faults may result from drift and catastrophic faults in sensors' sensing components leading to serious data inaccuracies. As a result, IoT sensors may become drifted, defunct, unreliable, and may output misleading data after running for some time. In an IoT/OT system, sensors may be installed on the assets and get connected to a storage and/or computation server through a network for data collection and processing. Any piece of the hardware or software that are used to support the operation of the sensors may become not functional and cause the wrong sensor readings. The fault can occur at a root layer (sensors), a network layer (network connectivity), a computation layer, or storage layers. While it is useful to detect faults at every layer to make the IoT/OT system operate correctly and continuously, the present disclosure focuses on the faults at the sensors, including the immediate links (part of network layer) to the sensors.

Currently, schedule-based inspection may not capture the faulty sensors in time while unnecessary inspection incurs additional cost. Also, such manual inspection may be error-prone and time-consuming. The present disclosure addresses an automatic data-driven approach to detect the faults in the sensors and even forecast the faults in the sensors. Additionally, root cause analysis may be performed on an individual fault basis, and design a systematic fault tolerance strategy to enable the IoT system continue operating uninterrupted despite the failure of one or more of the sensors. In some aspects, based on a detected faulty sensors, the system may identify and take remediation actions to repair or replace the sensors, so as to avoid any wrong decisions based on the readings from such faulty sensors.

### SUMMARY

Example implementations described herein include an innovative method. The method may include receiving sensor data from a plurality of related sensors. The method may further include identifying, for a first sensor in the plurality of related sensors, a set of correlated sensors in the plurality of related sensors. The method may also include detecting a fault in the first sensor based on at least one of the sensor data received from the sensor, the sensor data received from the set of correlated sensors, and the sensor data received from other sensors. The method may further include implementing a remediation strategy based on the detected fault of the first sensor.

Example implementations described herein include an innovative computer-readable medium storing computer executable code. The computer executable code may include instructions for receiving sensor data from a plurality of related sensors. The computer executable code may also include instructions for identifying, for a first sensor in the plurality of related sensors, a set of correlated sensors in the plurality of related sensors. The computer executable code may further include detecting a fault in the first sensor based on at least one of the sensor data received from the sensor, the sensor data received from the set of correlated sensors, and the sensor data received from other sensors. The computer executable code may also include instructions for implementing a remediation strategy based on the detected fault of the first sensor.

Example implementations described herein include an innovative apparatus. The apparatus may include a memory and at least one processor configured to collect a set of physical sensor data. The at least one processor may also be configured to receive sensor data from a plurality of related sensors. The at least one processor may further be configured to identify, for a first sensor in the plurality of related sensors, a set of correlated sensors in the plurality of related sensors. The at least one processor may also be configured to detect a fault in the first sensor based on at least one of the sensor data received from the sensor, the sensor data received from the set of correlated sensors, and the sensor data received from other sensors. The at least one processor may also be configured to implement a remediation strategy based on the detected fault of the first sensor.

Example implementations described herein include an innovative apparatus. The apparatus may include means receiving sensor data from a plurality of related sensors. The apparatus may further include means for identifying, for a first sensor in the plurality of related sensors, a set of correlated sensors in the plurality of related sensors. The apparatus may also include means for detecting a fault in the first sensor based on at least one of the sensor data received from the sensor, the sensor data received from the set of correlated sensors, and the sensor data received from other sensors. The apparatus may further include means for implementing a remediation strategy based on the detected fault of the first sensor.

### BRIEF DESCRIPTION OF DRAWINGS

FIG. 1 is a diagram illustrating a solution architecture for fault detection, fault prediction, fault remediation, and fault tolerance.

FIG. 2A is a diagram that illustrates steps used to identify the sensors that allow fault tolerance.

FIG. 2B is a diagram for bootstrapping a macro-similarity score.

FIG. 3A is a diagram illustrating calculating a micro-similarity score.

FIG. 3B is a diagram illustrating a method of bootstrapping a micro-similarity score.

FIG. 4A illustrates a method for a bivariate analysis to determine if related and/or corresponding sensors have experienced (or are experiencing) similar issues that indicate an operational anomaly or have not, or are not, experiencing similar issues that indicates that the sensor is faulty.

FIG. 4B is a diagram illustrating a first ensemble approach for sensor-fault detection.

FIG. 5 is a diagram illustrating a second ensemble approach for sensor-fault detection.

FIG. 6 is a diagram illustrating an example fault prediction module.

FIG. 7 is a flow diagram of a method of detecting, and remediating, faults in sensors associated with a system.

FIG. 8 is a diagram further expanding the view of the sub-operations performed to identify the set of correlated sensors in the plurality of related sensors at in some aspects.

FIG. 9 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

In this disclosure, a system, an apparatus, and a method are presented that addresses problems associated with conventional sensor-fault detection techniques. For example, conventional approaches may fail to detect faults in sensors in time, which may lead to wrong readings, cause damage to the systems, generate incorrect insights, and lead to bad decisions. Moreover, conventional approaches may detect faults after the faults have already happened, and thus the faults may not be remediated or avoided proactively. While some approaches use traditional time series forecasting techniques to forecast anomalies in the data, the existing approaches may be unable to distinguish sensor faults from operational faults in the underlying systems. Manual inspection of IoT sensors may be error-prone and time-consuming, for example, schedule-based inspection of IoT sensors may not capture the faulty sensors in time thus incurring the risk of getting wrong sensor readings and unnecessarily aggressive inspection schedules designed to mitigate the risk of wrong sensor reading may associated with additional unnecessary costs.

In this disclosure, a system, an apparatus, and a method are presented that provide techniques related to detecting faults in sensors associated with a system (e.g., IoT sensors associated with an industrial and/or manufacturing system and/or process). The method may include receiving sensor data from a plurality of related sensors. The method may further include identifying, for a first sensor in the plurality of related sensors, a set of correlated sensors in the plurality of related sensors. The method may also include detecting a fault in the first sensor based on at least one of the sensor data received from the sensor, the sensor data received from the set of correlated sensors, and the sensor data received from other sensors. The method may further include implementing a remediation strategy based on the detected fault of the first sensor.

Generally, to solve some of the problems identified above, the method may involve, one or more of critical sensor identification, fault tolerance identification, fault detection, fault prediction, fault remediation, and/or fault tolerance. For example, critical sensor identification may include identifying one or more critical sensors based on domain knowledge, data analysis, or downstream tasks. The critical sensors may include sensors that capture critical data for monitoring a health of an underlying system and/or that capture critical data used for at least one of identifying a remediation strategy, deriving business insights, or building solutions for problems relating to a set of related downstream tasks such as anomaly detection, failure prediction, remaining useful life prediction, and so on.

Fault tolerance identification, in some aspects, may include identifying a set of one or more correlated sensors for each critical sensor (e.g., sensor-of-interest). The identified correlated sensors may include one or more sensors which capture similar or highly correlated signals based on similarity metrics, where several approaches may be used to calculate one or more similarity scores (e.g., similarity scores associated with the similarity metrics) between data of two sensors. Fault detection may, in some aspects, include detecting a fault in on or more sensors based on data from physical sensors and/or data associated with virtual sensors (e.g., expected data for a virtual sensor based on related data from one or more physical sensors processed using one or more physics-based models). Fault detection may include, in some aspects, one or more of univariate anomaly detection, bivariate anomaly detection, and/or multivariate anomaly detection approaches, and may further involve an ensemble algorithm based on the one or more of the univariate, bivariate, or multivariate anomaly detection approaches.

In some aspects, fault prediction may include predicting a fault in one or more sensors (e.g., critical sensors). The fault prediction may be based on a deep learning recurrent neural network (RNN) model using sensor data from at least the critical sensor and additional sensors (e.g., a set of related and/or correlated sensors). Based on the fault prediction, in some aspects, the method may include identifying fault remediation and/or fault tolerance actions. The fault remediation actions (e.g., repairing or replacing the sensor predicted to fail) may be based on a root cause analysis related to the fault prediction and may further be based on domain knowledge that indicates one or more remediation takes based on the results of the root cause analysis. In some aspect, a failure prediction for a particular sensor of interest may cause the system (or method) to identify (or retrieve the identity of) a set of correlated sensors that may be used in place of the particular sensor of interest until the sensor is repaired or replaced.

As described in more detail below, the apparatus and method described herein may provide a data-driven approach for fault detection in sensors that can distinguish between faults in sensors and operational failures in the underlying systems based on a novel combination of univariate and bi/multivariate anomaly detection. In some aspects, the data driven approach uses data from a plurality of sensors (e.g., a set of correlated and/or related sensors) associated with a system to detect and/or predict a failure of a particular sensor of interest. The data driven approach including the one or more of critical sensor identification, fault tolerance identification, fault detection, fault prediction, fault remediation, and/or fault tolerance, in some aspects, may allow (1) remediation before a fault occurs to avoid damages to an unmonitored underlying system based on the faulty sensor by providing a fault prediction as well as fault detection, (2) reducing manual labor costs and/or undetected faults associated with a maintenance schedule by providing real time fault detection, (3) reducing human error in the sensor maintenance and diagnostics by relying on data, (4) conclusions to be drawn based on the existing evidence, and (5) identifying fault tolerance actions/opportunities such as relying on data collected by correlated sensors (or a ‘digital twin model’ for the sensor of interest) until the sensor of interest is repaired or replaced based on a fault tolerance identification operation provided herein. The data driven approach in some aspects may rely on both current and historical data from the sensor of interest as well as from the set of correlated sensors.

The system, apparatus, and/or method may provide automated root cause analysis. Root cause analysis of failures, may be performed manually based on domain knowledge and data visualization, which may be subjective, time consuming, and prone to errors. In some cases, the root causes may be associated with raw sensor data that is not addressed by domain knowledge or the data visualizations used for the manual root cause analysis. The system, apparatus, and/or method may provide automated root cause based on a standardized approach to identify the root cause of the predicted failures.

In some aspects, sensor data (e.g., IoT sensor data, vibrational data) may be high frequency data (e.g., 1000 Hz to 3000 Hz). High frequency data, in some aspects, poses challenges to build the solution for the failure prediction problem. For example, high frequency data may be associated with high levels of noise or long or resource consuming analysis (e.g., computing) times. A sampling frequency or aggregation window may require optimization for accurately predicting one of a short-term failure or a long-term failure. Accordingly, the system, apparatus, and/or method may provide a window optimization operation to identify an optimized window and or aggregation statistics for a failure prediction.

In some aspects, the physical sensor data may not be able to capture all the signals that may be useful for monitoring the system due to the severe environment for sensor installation, the cost of the sensors, and/or the functions of the sensors. As a result, the collected data may not be sufficient to monitor the system health and capture the potential risks and failures. In some aspects, this inability to capture all the potentially useful signals may pose challenges to building a failure prediction solution. Accordingly, the system, apparatus, and/or method may enrich the physical sensor data in order to capture necessary signals to help with the system monitoring and building failure prediction solution. For example, the physical sensor data may be processed by a set of physics-based models to generate virtual sensor data.

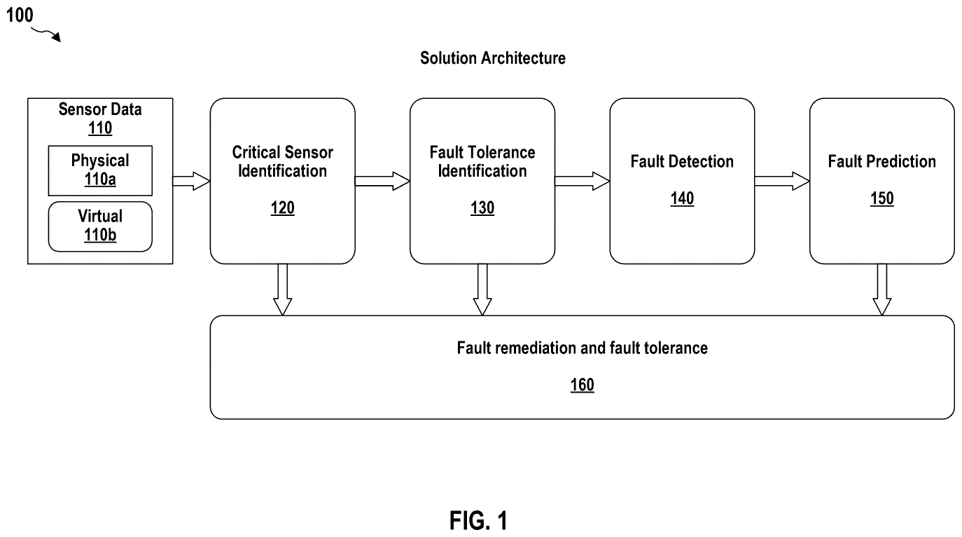

FIG. 1 is a diagram 100 illustrating a solution architecture for fault detection, fault prediction, fault remediation, and fault tolerance. The solution architecture may include a sensor data module 110. The sensor data module 110 may incorporate a set of physical sensors 110a and a set of virtual sensors 110b. The physical sensors 110a may include one or more of any of temperature sensors, pressure sensors, vibration sensors, acoustic sensors, motion sensors, level sensors, image sensors, proximity sensors, water quality sensors, chemical sensors, gas sensors, smoke sensors, IR sensors, acceleration sensors, gyroscopic sensors, humidity sensors, optical sensors, and/or LIDAR sensors. The data from the physical sensors 110a may be provided to a set of physics-based models to generate data associated with the virtual sensors 110b.

In some aspects, physical sensors 110a may be installed on assets of interest (e.g., assets within an OT system) and may be used to collect data to monitor the health and the performance of the asset. Different types of sensors are designed to collect different types of data among different industry, different assets, and different tasks. While different sensors may be included in the physical sensors 110a for different applications, the disclosure discusses them generically as the method may be applied to a wide range of sensors and data types. Virtual sensors 110b, in some aspect, may be associated with output variables from a set of physics-based models or a set of digital twin models, which can complement and/or validate the data from the physical sensors and thus help monitor and maintain the system health. For the “complement” case, when the physical sensor data is not available or not enough, virtual sensor data from the digital twin model can serve as a “substitute” of the physical sensors. For the “validate” case, assuming the physical sensors also collect the data as the outputs of the digital twin model, the virtual sensor data can serve as the “expected” value while the values from physical sensors can serve as the “observed” value and thus the variance or difference between them can be used as a signal to detect abnormal behaviors in the system.

The data collected by one sensor S1, in some aspects, may be closely related to the data collected by another sensor S2. In this case, S1 can be a substitution of S2 and vice versa. For example, the wind turbine axis torque could be approximately represented by the amount of vibration generated by a generator and vice versa. Such substitutional relationships can be obtained based on domain knowledge and/or data analysis (such as correlation analysis). Substitute sensors allow fault tolerance: when one sensor is not functional, the other sensor may be used as a substitute to build the solution. Additionally, faulty sensor(s) may be recognized when such substitute relationships fail to hold.

The sensor data from the sensor data module 110 may be provided to a critical sensor identification module 120. In some aspects, multiple sensors may be installed on assets in the industrial systems to monitor the health of the system, but only some of the sensors are useful to derive insights and make decisions, and/or build solutions for the downstream tasks. Such sensors are critical to maintain a healthy, reliable, and continuously operating industrial system and we need to keep these sensors functioning as expected. Such sensors may be referred to as critical sensors and special attention may be payed to these critical sensors beyond that payed to other non-critical sensors in the system. There are several approaches to identify the critical sensors that may be employed by the critical sensor identification module 120.

In some aspects, a domain-knowledge based approach may be used. For example, operators and/or technicians may often possess domain knowledge that allows them to identify which sensors are useful and critical to monitor the health of the system. In some aspects, the operators and/or technicians may provide input into the critical sensor identification module 120 to identify critical sensors. For example, their domain knowledge may be used to identify a list of critical sensors ranked by their importance.

A data-driven approach may also be used to identify one or more critical sensors. For example, one or more variables used to indicate the health of the system may be identified and a data analysis may be performed on historical data from a plurality of sensors associated with the system to identify which sensor(s) are closely related to the health indicator variable. One approach is to calculate the correlation coefficient between each sensor's data and the health indicator variable. As a result, we can have a list of sensors ranked by their correlation coefficients.

The sensor data may be used to build solutions for some downstream tasks, including but not limited to: failure prediction, anomaly detection, remaining useful life, yield optimization, and so on. As the solution for the downstream tasks is built based on the data from multiple sensors, we can identify the importance of the sensors for such solutions through one or more downstream-task based approaches (e.g., feature selection techniques and/or explainable AI techniques). Based on the model built based on the downstream task, the system and/or method may calculate a value reflecting a feature importance for each sensor (e.g., a value related to the explanatory effect of the sensor data on the downstream task). The one or more downstream-task based approaches, in some aspects, provides a list of sensors ranked by their importance.

The above approaches, e.g., the domain-knowledge based approach, the data-driven approach, and the downstream-task based approach may be used independently to identify the critical sensors. In some aspects, the different approaches may be combined into one approach by merging the ordered list of sensors generated by the different approaches. For example, one possible approach is to calculate the average ranking of each sensor based on its rankings in the three lists and then reorder the sensors based on the average ranking. When calculating the average ranking, we can use weighted average by assigning a weight to each approach first and use the weighted rank to calculate the average rank.

Fault tolerance identification module 130 may be used to identify one or more sensors that may provide substitute sensor data for a critical sensor. For example, given a sensor S1, a set of one or more sensors that can serve as the substitutes of the sensor S1 may be identified. Based on the set of one or more sensors identified by fault tolerance identification module 130 and a predicted or detected failure of the sensor S1, the set of one or more “substitute” sensors, at least for some time period until S1 is repaired or replaced, may be used in place of sensor S1.

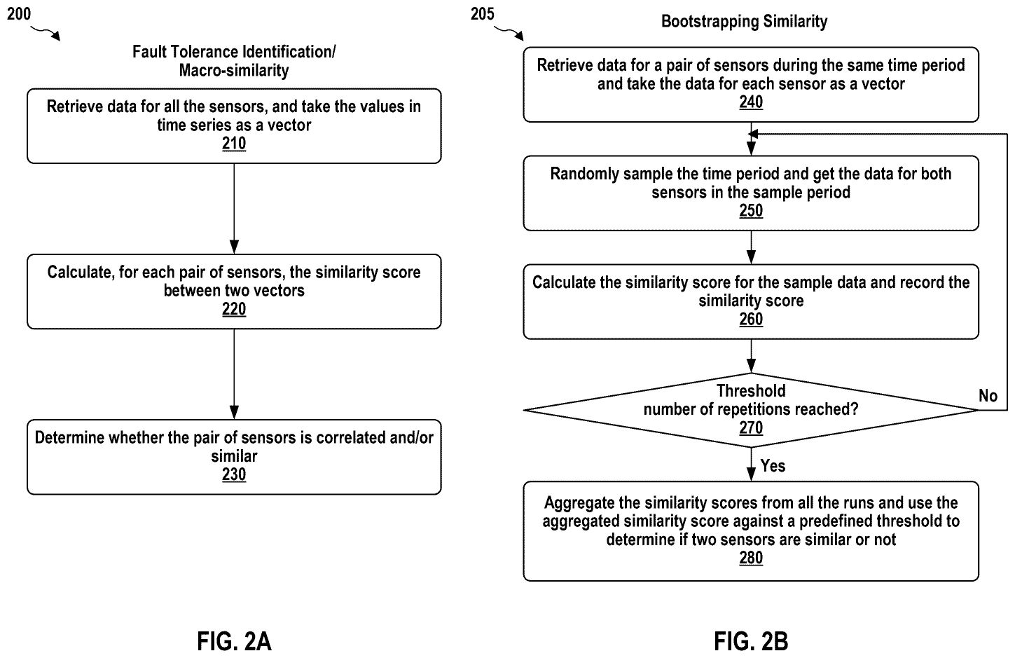

FIG. 2A is a diagram 200 that illustrates steps used to identify the sensors that allow fault tolerance. At 210, the method may retrieve data for all the sensors, and take the sensor data values in time series as a vector. The sensors, in some aspects, may be physical sensors and/or virtual sensors from digital twin models. At 220, the method may calculate, for each pair of sensors, a similarity score between the two vectors for the pair of sensors. To make the comparison, some aspects normalize the data from the pair of sensors so that they can be compared. For example, the data from the pair of sensors may have initially been collected during different time periods or may have been collected with a different frequency and the method may sample the data from the different sensors to make the time window and data frequency the same. Once the data is normalized, the method may select one or more similarity metrics. The one or more similarity metrics may include, but are not limited to, a correlation coefficient, a cosine similarity, a Hamming distance, a Euclidean distance, a Manhattan distance, and/or a Minkowski Distance. Based on the one or more selected similarity metrics, the method may measure the similarity between the two vectors. Calculating the similarity score between the two vectors for the pair of sensors may include one of several approaches. In theory, the method may calculate a similarity score for each possible pair of sensors (e.g., physical sensors and/or virtual sensors), but in some aspects, the similarity score may be calculated for the critical sensors and each of the other sensors (including both critical sensors and non-critical sensors).

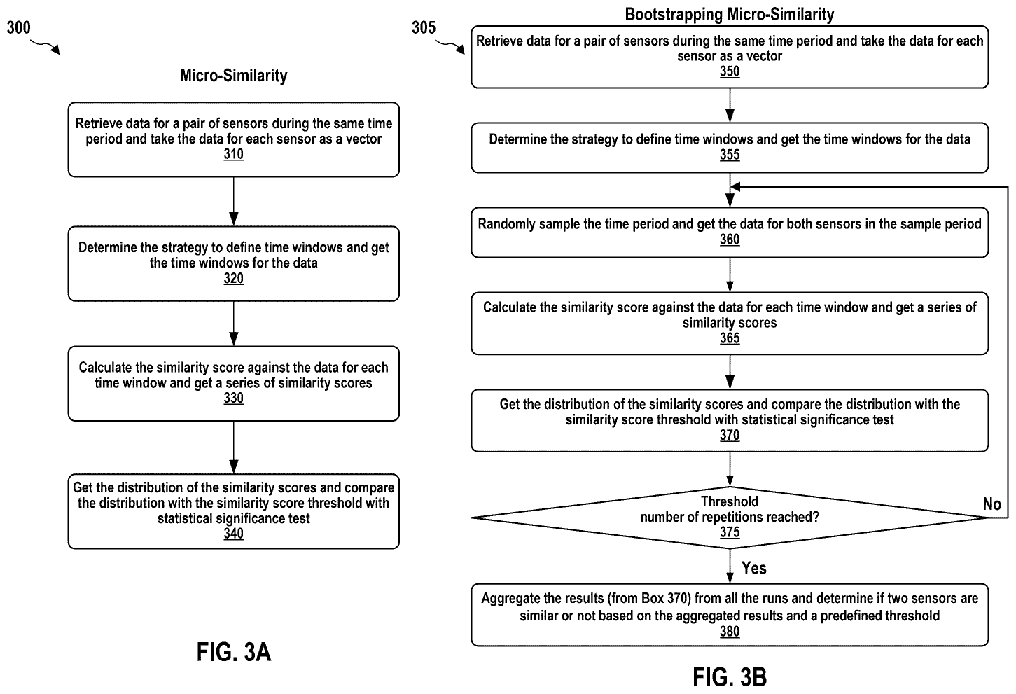

The similarity scores calculated at 220 may be compared to a threshold similarity score to determine, at 230, if the two sensors are correlated and/or related. If the calculated similarity scores are above the threshold value, the similarity may be verified based on domain knowledge by an operator and/or technician. The similarity determined at 230 may be referred to as a macro-similarity based on a comparison of larger data sets (e.g., data collected for 1 day, 1 week, and so on) than would be used to determine a micro-similarity as described below in relation to FIGS. 3A and 3B. As described above, the macro-similarity may be used to determine a set of “substitute” sensors for a critical sensor or a set of related and/or correlated sensors for remediation or other downstream tasks.

FIG. 2B is a diagram 205 for bootstrapping a macro-similarity score. If the two data vectors from the two sensors are beyond a threshold length, a similarity computation may take a lot of resources and a very long time to finish. Diagram 205 shows a workflow relating to how to use a bootstrapping technique to calculate similarity score. Diagram 205 illustrates that the method may include retrieving data at 240 as described above in relation to step 210 of diagram 200.

After retrieving the data, the method may determine (not shown) whether to analyze the full data sets or a reduced (e.g., bootstrapping) data set. The reduced (e.g., bootstrapping) technique, may include sampling, at 250, corresponding data from each of the two vectors. For example, the method may, at 250, sample from two vectors with replacement by a predefined sampling rate, say 0.01, and used to compute and or calculate, at 260, the similarity score. Calculating the similarity score at 260 is similar to calculating the similarity described in relation to 220 of diagram 200 only performed on a smaller widow of time than normal.

After calculating a similarity score for a current sample, the method may proceed to determine, at 270, whether a threshold number of repetitions has been met (each repetition being associated with a sampling-based similarity score. The threshold number of repetitions may be configured prior to the analysis and may be selected to be large enough to ensure that the calculated values are reported values. If the threshold number of repetitions has not been met, the method may return to step 250. Accordingly, the method may repeat such a process multiple times to get multiple similarity scores. The method may then, at 280, aggregate the similarity scores from multiple runs and use the aggregated value as the final similarity score. The aggregation function used at 280 may include, but is not limited to mean, weighted mean, maximum, minimum, median, weighted median, and so on. Then, based on the aggregated similarity score, we can compare, also at 280, the aggregated similarity score with a predefined similarity score threshold to determine whether two vectors are similar or not.

FIG. 3A is a diagram illustrating calculating a micro-similarity score. In some aspects, instead of calculating one similarity score (or aggregated similarity score) as described in relation to step 220 and 280, the method may calculate a series of similarity scores based on the data in time windows (or time segments). FIG. 3A shows a workflow 300 on how the micro similarity calculation works. As for generating the macro-similarity score in FIG. 2A, the method may first retrieve, at 310, the data for a pair of sensors during a same (or overlapping) time window. At 220, the method may determine a strategy used to define the time windows that will be used in calculating the micro-similarity score. The time windows, in some aspects, are one of be rolling windows or adjacent windows. The time windows can also be event dependent. For example, holiday season, business operation hours within a day, weekdays, weekends, and so on may be used to identify a time window.

For each time window, the method, at 330 may calculate a similarity score, and as a result we will have a series of similarity scores for each pair of sensors. The method may then, at 340, get a distribution of the similarity scores based on their values and frequencies and analyze the distribution of the similarity scores. To determine whether two sensors are similar, the method may perform a statistical significance test to determine if a predefined similarity score threshold is significantly different from the distribution of similarity scores. For instance, the method may use a one-sample one-tail t-test (or other appropriate statistical analysis) to determine if the similarity score threshold is significantly below the similarity scores. The method may first calculate a statistic based on the data for the similarity score threshold against the distribution of the similarity scores. Then based on the significance level, the method may determine whether the similarity score threshold is significantly below the similarity scores. In this case, we focus on one-tail test, i.e., the left tail in the distribution of similarity scores. Micro similarity provides fine-grained view of the similarity scores and thus is more informational and accurate to represent the similarity of two sensors.

FIG. 3B is a diagram 305 illustrating a method of bootstrapping based on micro-similarity. Similarly to the relationship between FIGS. 2A and 2B, FIG. 3B illustrates that the first two steps of the method, i.e., retrieving the data at 350 and determining the strategy to define the time windows at 355 are equivalent to steps 310 and 320 respectively. In a micro-similarity approach, if there are too many time windows, the calculation may take many resources and too much time to run. Accordingly, the method illustrated in diagram 305 may use the bootstrapping techniques to solve such problems. Once the method determines the windowing strategy and defines all the time windows at 355, we can use bootstrapping technique to sample, at 360, the time windows with replacement by a predefined sampling rate, say 0.01. Then the method may apply, at 365, the micro similarity approach to calculate a series of similarity scores and the distribution of the similarity score. The method may, at 370, compare the similarity score threshold with the distribution of similarity scores based on a statistical significance test and the result of the current run is recorded. At 375, the method determines whether additional runs are to be performed. If so, the method may return to 360 to perform another random sampling of the time windows defined at 355. The sampling runs may continue with several runs of the bootstrapping sampling and application of micro similarity approach, until a predefined number of runs has been reached. The results from the predefined number of runs may be aggregated, at 380, to get a final result. Since the result from each run is a binary value to indicate whether the similarity score is significantly below the similarity scores (meets a threshold criteria for identifying similarity via the identity score), some aspects, use a “majority vote” technique to see which binary value dominates the results and use that as the final result. In other aspects, if the result from each run is represented by a numerical score to indicate the statistical significance, we can use an average or weighted average technique to compute the average statistical significance value as the final result. Finally, in some aspects, determining if two sensors are similar includes, if the calculated similarity scores are above the threshold value, the similarity may be verified based on domain knowledge by an operator and/or technician. Generally speaking, the approaches to calculate bootstrapping similarity, micro similarity, and bootstrapping micro similarity, each of them transforms the original calculation against big vectors into multiple calculations on small vectors, which lower the hardware requirements. As a result, the analysis may be capable of being performed at edge devices (e.g., devices that may have limited hardware resources) with these approaches.

In some aspects, given a sensor S1, there may not be one single sensor that can serve as a substitute for sensor S1, and the method may select a group of sensors as a whole that can be used as a substitute of the sensor S1. One approach is to use the sensor S1 as a target and the rest of the sensors as features to build a machine learning model. If the model performance metrics is above some predefined threshold, then we can tell that the sensor S1 can be substituted by a set of one or more correlated (or related) sensors. To determine the substitute sensors, the method can select important features from the model and use the corresponding sensors as the substitute sensors of the sensor S1. Feature selection can be done based on some feature selection techniques, including but not limited to forward selection, backward selection, model-based feature selection, and so on. Domain knowledge, in some aspects, may be incorporated to improve the feature selection. The group of sensors that are used as substitute of the sensor of interest (in this case, S1) are called cohort sensors, related sensors, or correlated sensors. Besides using a group of cohort sensors as a substitute of the sensor of the interest, we can also use the output from the machine learning model (or a set of physics-based models associated with virtual sensors) as a substitute of the sensor of the interest.

Besides identifying the similarity between sensors based on sensor data, the method described herein may also incorporate some domain knowledge, if available. For example, some example sensors that may have high similarity are a) physical sensors for input variables and the input variables in the motion profile by design; b) physical sensors for output variables and the output variables from digital twin models (can be based on input variables from either motion profile by design or physical sensors for input variables); and/or c) output variables from different versions of digital twin models (can be based on input variables from either motion profile by design or physical sensors for input variables).

The methods described in relation to FIGS. 2A to 3B may relate to, and/or be performed by, the critical sensor identification module 120, and/or the fault tolerance identification module 130. Based on the output of the fault tolerance identification module 130 and, in some aspects, the critical sensor identification module 120 a fault detection module 140 may perform fault detection operations. For example, after the critical sensors are identified by critical sensor identification module 120 and similar sensors are identified for the critical sensors (if possible) by the fault tolerance identification module 130, one or more data-driven approaches may be used to detect faults in the critical sensors. The data can be physical sensor data and/or virtual sensor data from digital twin. The approaches, in some aspects, may involve one or more machine learning models, including a univariate anomaly detection model, a bivariate anomaly detection model, and/or a multi-variate anomaly detection model.

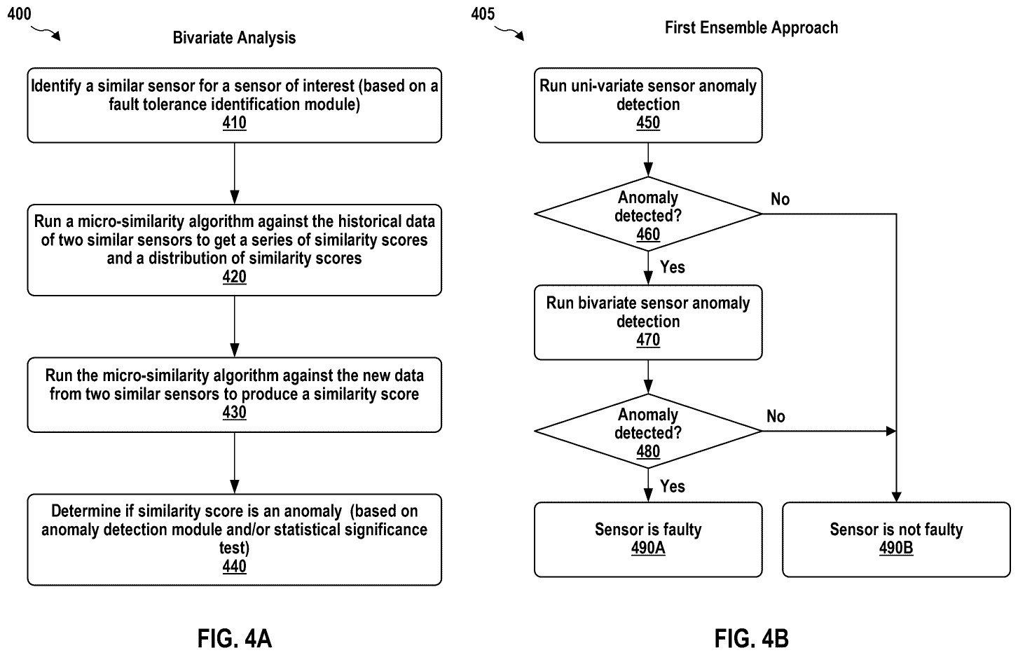

For a sensor of interest, a univariate anomaly analysis may include running an anomaly detection model against the sensor's data. The anomaly in the temporal sequence of data may indicate either faulty sensors or operational anomaly. Accordingly, a second anomaly analysis is performed, in some aspects, to distinguish between a faulty sensor and an operational anomaly. For example, FIG. 4A illustrates a method 400 for a bivariate analysis to determine if related and/or corresponding sensors have experienced (or are experiencing) similar issues that indicate an operational anomaly or have not, or are not, experiencing similar issues that indicates that the sensor is faulty. For example, at 410, for the sensor of the interest, the method first identify a similar sensor based on the output from the fault tolerance identification module 130. For the cohort sensor case, the method may use the output from the machine learning model based on a group of cohort sensors as the similar sensor.

At 420, the method may then run the micro similarity algorithm against historical data from the sensor of the interest and the similar sensor as described above in relation to FIGS. 3A and 3B above to calculate a series of similarity scores. the method can also get a distribution f of the similarity scores. After running the micro similarity algorithm against historical data, at 430, the method then run micro similarity against the new data from the sensor of the interest and the similar sensor and get a current similarity score.

Finally, at 440, the method may then check if the similarity score based on the historical data and the similarity score based on the current data differ to a degree indicating a faulty sensor. For example, an anomaly detection model can be run against the series of similarity scores to detect such difference or anomaly and/or the method can perform statistical significance test for the similarity score against the distribution of the similarity scores. A one-sample t-test can be performed by choosing a significance level, for example, 0.01. The anomaly detected by bivariate anomaly detection model usually indicates there is a fault in the sensor of the interest or the similar sensor.

In some aspects, data from the plurality of sensors may be used to build a multi-variate anomaly detection model. Such anomaly usually indicates system operational anomaly, assuming that the likelihood of multiple sensors failing at the same time is low. Among the three above approaches, the univariate anomaly detection model may not be able to distinguish between an anomaly due to sensor fault or system operation failure; the bivariate anomaly detection model may not be able to determine which of the two sensors has a fault; and the multi-variate anomaly detection model only detects system operation anomaly. To address these limitations, some approaches use an ensemble, or combination, of the above approaches to determine which sensor has fault. We introduce two approaches for this purpose. Each approach can run independently to detect faults in the sensors.

FIG. 4B is a diagram 405 illustrating a first ensemble approach for sensor-fault detection. In the first ensemble approach as shown in diagram 405, the outputs from univariate anomaly detection model run at 450 and the bivariate anomaly detection model run at 470 may be used to detect faults in the sensor. This approach makes use of the existence of related or corresponding sensor(s) for the sensor of interest. As noted above, the similar (e.g., related or correlated) sensors may be detected by fault tolerance identification module 130. For example, referring to FIG. 4B, the first ensemble approach may include running univariate anomaly detection model against the vector of the sensor data for a particular sensor of interest (e.g., a critical sensor) at 450. Based on the univariate anomaly detection model run at 450, the method may determine at 460 if an anomaly was detected. If no anomaly was detected, the sensor may be determined, at 460, to be not faulty at 490B. However, if an anomaly was detected by the univariate anomaly detection model run at 450, the method may run a bivariate sensor anomaly detection model against the vectors of the sensor of interest and the related/correlated/similar sensor(s) at 470. Based on the bivariate anomaly detection model run at 470, the method may determine at 480 if an anomaly (e.g., an anomaly between the output of the sensor of interest and the related/correlated/similar sensor(s)) was detected. If no anomaly is detected (e.g., the related/correlated/similar sensor(s) produce measurements/vectors that are similar to the measurements/vectors produced by the sensor of interest sensor), then the sensor of interest may be determined, at 480, to be not faulty 490B. However, if, based on the bivariate anomaly detection model run at 470, an anomaly was detected, the sensor of interest may be determined, at 480, to be faulty at 490A as there is evidence that the sensor of interest (or critical sensor) data is inconsistent with the sensor data collected by the related/correlated/similar sensors and since univariate anomaly detection models identify an anomaly in the sensor of interest we can conclude that the sensor of interest is faulty.

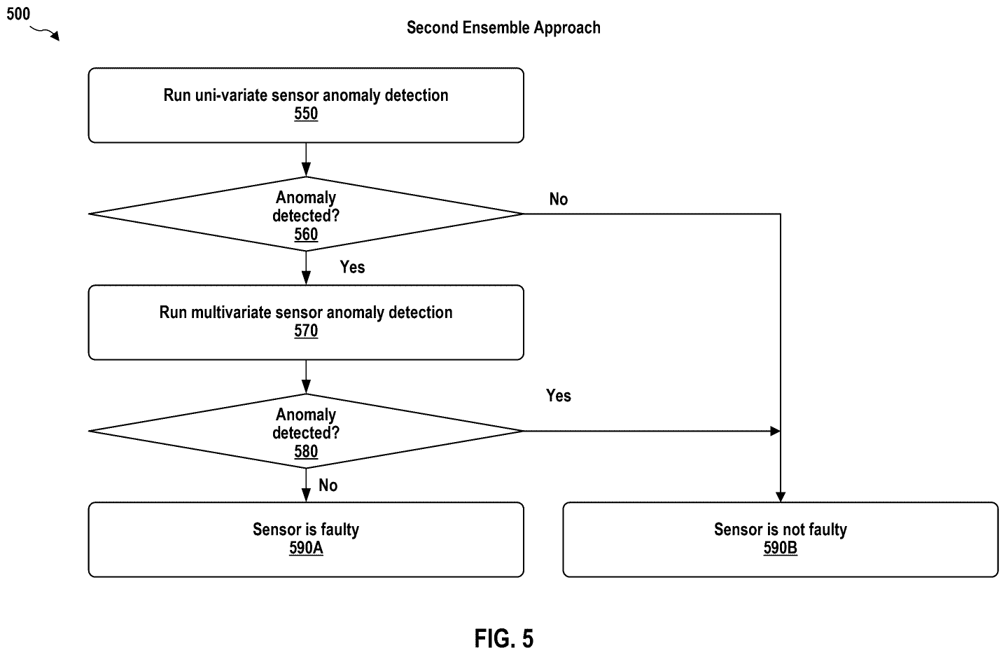

FIG. 5 is a diagram 500 illustrating a second ensemble approach for sensor-fault detection. In the second ensemble approach as shown in diagram 500, the outputs from univariate anomaly detection model run at 550 and the multivariate anomaly detection model run at 570 may be used to detect faults in the sensor. The second ensemble approach may include running univariate anomaly detection model against the vector of the sensor data for a particular sensor of interest (e.g., a critical sensor) at 550. Based on the univariate anomaly detection model run at 550, the method may determine at 560 if an anomaly was detected. If no anomaly was detected, the sensor may be determined, at 560, to be not faulty at 590B. However, if an anomaly was detected by the univariate anomaly detection model run at 550, the method may run a multivariate sensor anomaly detection model against the vectors of all the (critical) sensors (including the sensor of interest). Based on the multivariate anomaly detection model run at 570, the method may determine at 580 if an anomaly was detected. If an anomaly is detected, then the sensor may be determined, at 580, to be not faulty 590B (e.g., if the multivariate anomaly detection model based on all the (critical) sensors detects an anomaly it is likely a system/operational fault and not a sensor fault). However, if, based on the multivariate anomaly detection model run at 570, no anomaly was detected, the sensor may be determined, at 580, to be faulty at 590A as the multivariate anomaly detection model doesn't identify any system/operational fault and thus it is likely a sensor fault.

In some aspects additional considerations may be used to determine a faulty sensor. For example, if the sensor fails to produce any data readings, then the sensor may be determined to be faulty. In some aspects, the first and second ensemble approaches may run concurrently and detect faulty sensors. If both approaches detect faults in the sensor, then the sensor may be determined to be faulty. If both approaches fail to detect faults in the sensor, then the sensor may be determined to be not faulty. If one approach detects faults in the sensor and the other does not, then output either faulty sensor or not fault sensor depending on the risk versus cost tradeoff.

When building an anomaly detection model, the time-series data, in some aspects, may be preprocessed before having the model applied to the preprocessed data. Some preprocessing techniques may include but are not limited to: differencing, moving average, moving variance, window-based features, and so on. The approach can be applied to both analog and digital sensors. For digital sensors, we can first preprocess the data with moving average and/or moving variance, then the data will become continuous values.

The anomaly detection, in some aspects may be a distribution-based method. For example, a moving variance based on the sensor data may be calculated first and then a distribution of the moving variance may be calculated or determined. Based on the distribution of the moving variance, the anomaly detection (e.g., performed by an anomaly detection module) may identify outliers/anomalies based on a predefined threshold (for example, out of 99% range). Such outliers/anomalies, in some aspects, may be determined to correspond to the faulty sensors. The assumption here is that if the sensor data stays at the same value for some time (i.e., moving variance is close to 0), then a deviation from that value corresponds a fault in the sensor.

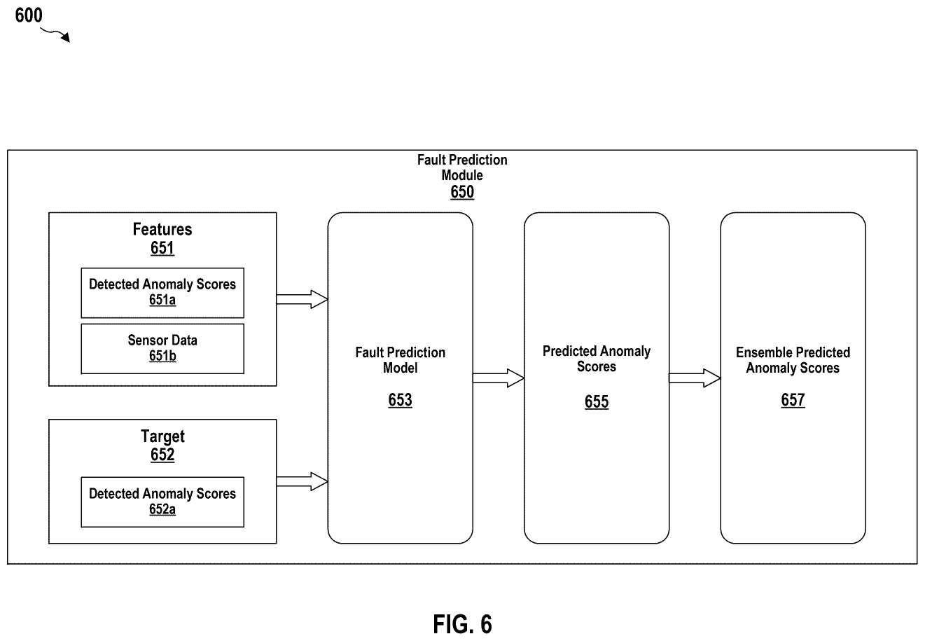

With fault detection techniques, faults may be detected when the faults happen. While repairing and/or replacing the faulty sensor, the underlying system may be left unmonitored due to the downtime of the sensor. In order to avoid leaving the underlying system unmonitored during maintenance/repair, in some aspects, a fault prediction module is provided to predict sensor faults ahead of time to avoid sensor faults or allow for remediation without downtime during which the system is unmonitored. FIG. 6 is a diagram 600 illustrating an example fault prediction module 650. In some aspects fault prediction module 650 corresponds to the fault prediction module 150 of FIG. 1. The fault prediction module 650 may run a set of anomaly detection models 651a and/or 652a to get a corresponding set of anomaly scores. The set of anomaly detection models may include one or more of a univariate anomaly detection model for each sensor's data, a bivariate anomaly detection model for each pair of identified related/correlated/similar sensors, or a multivariate anomaly detection model as described above to generate the set of anomaly scores.

The fault prediction module 650 may identify and/or prepare features (e.g., at features module 651) associated with a set of sensors (e.g., associated with sensor data 651b). For example, for each sensor, the fault prediction module 650 may retrieve the following data: (1) the data from the sensor and similar sensors (if available), (2) the anomaly score from the univariate anomaly detection model, (3) the anomaly score from the bivariate anomaly detection model, and (4) the anomaly score from the multivariate anomaly detection model. The fault prediction module 650 may additionally prepare targets (e.g., at target module 652), for each sensor, where preparing the targets may include retrieving, for an associated lead time, one or more of (1) the anomaly score from the univariate anomaly detection model, (2) the anomaly score from the bivariate anomaly detection model, and/or (3) the anomaly score from the multivariate anomaly detection model, where the lead time may be a predefined value indicating how far ahead an anomaly is predicted. Based on the retrieved data, the fault prediction module 650 may build a sequence prediction model (e.g., fault prediction model 653). The sequence prediction model, in some aspects, may be a deep learning recurrent neural network (RNN) used for sequence prediction. The deep learning RNN may be one of a long short-term memory (LSTM) model or a gated recurrent unit (GRU) model. The deep learning RNN model, in some aspects, may allow multiple targets at once such that the output from each prediction include three anomaly scores: univariate, bivariate, and multivariate anomaly scores (e.g., associated with predicted anomaly scores 655). Finally, the ensemble approaches discussed above in relation to FIGS. 4B and 5 may be applied by ensemble predicted anomaly scores module 657 to predict whether the sensor is faulty.

Fault remediation and fault tolerance module 160 may receive information from one or more of the critical sensor identification module 120, the fault tolerance identification module 130, and/or fault prediction module 150. Once a fault is predicted, the fault remediation and fault tolerance module 160 may use an explainable AI technique (such as ELI5 and Shapley additive explanations (SHAP)) to identify the root cause of the fault. In this case, the fault remediation and fault tolerance module 160 may identify a data point (or critical sensor) and/or root cause associated with the predicted fault. Postprocessing the predicted anomaly score and the root causes may be used to verify the fault with or without applying domain knowledge. If the fault is valid, the fault remediation and fault tolerance module 160 may identify one or more remediations (including identifying “substitute” sensors) that may be implemented by an operator or technician. For example, identifying the one or more remediations may include checking if a faulty sensor has a related/correlated/similar set of sensors to allow fault tolerance. If a related/correlated/similar set of sensors exists, the identified one or more remediations may include using the related/correlated/similar set of sensors for the downstream tasks and replacing the faulty sensor. If the related/correlated/similar set of sensors does not exist and/or could not be identified, the identified one or more remediations may include immediately replacing the faulty sensor and adding at least one additional sensor to provide redundancy in the future. The identified one or more remediations may include geolocation-based faulty sensor remediation such that if there are sensors of the same type sequentially (e.g., upstream or downstream from the faulty sensor), the upstream and/or downstream sensors may be used to impute the faulty sensor values. The identified one or more remediations may also include a time-based faulty-sensor remediation, such that if for some reason, the sensor produces faulty values only for a particular period of time, data before the fault and after the fault may be used to impute the sensor values during the faulty time period.

In some aspects, during design time and/or operation time, fault tolerance may be introduced systematically. For example, digital twin models may be built to output virtual sensor data as the fault tolerance substitute for physical sensor data. In some aspects, virtual sensors from digital twin models may help complement and validate the physical sensors. More than one version of the digital twin model may be built, in some aspects, to allow more fault tolerance and data validation. In some aspects, the introduction of fault tolerance may include identifying critical sensors and introducing at least one additional sensor for fault tolerance if no similar sensor is available. For example, in a service-oriented architecture (SOA), there may be a desire for ensuring fault tolerance for the critical sensors.

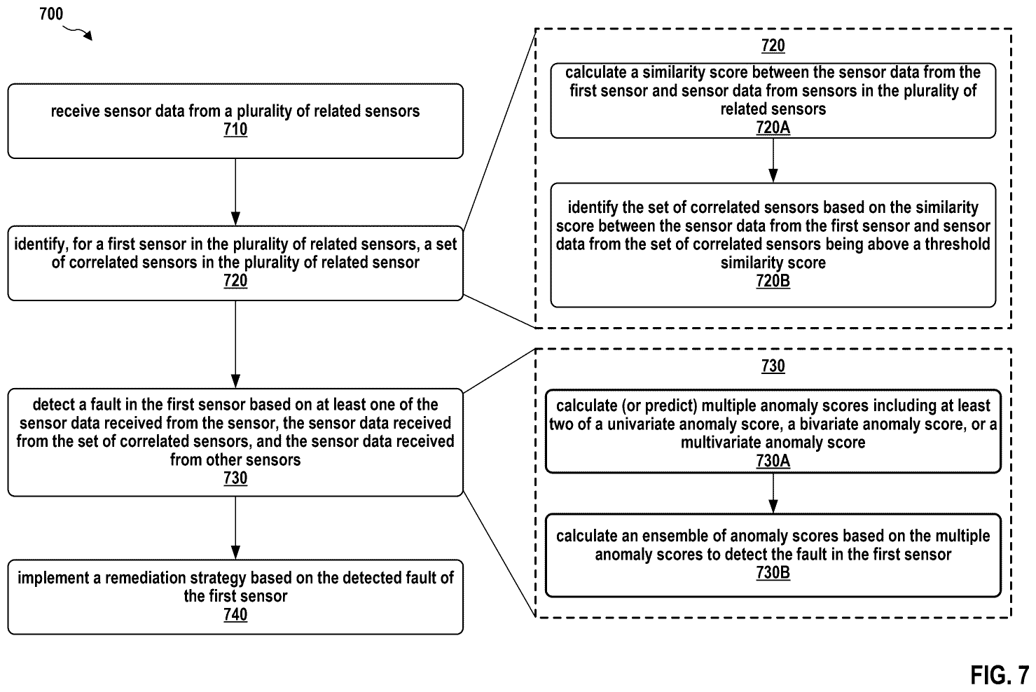

FIG. 7 is a flow diagram 700 of a method of detecting, and remediating, faults in sensors associated with a system. The method may be performed by a system such as the solution architecture illustrated in diagram 100 or one or more of the components of the solution architecture individually or in combination, e.g., the sensor data module 110, the critical sensor identification module 120, the fault tolerance identification module 130, the fault detection module 140, the fault prediction module 150 (or 650), and/or the fault remediation and fault tolerance module 160. At 710, the method may receive sensor data from a plurality of related sensors. In some aspects, the plurality of related sensors are sensors monitoring a same system. The plurality of related sensors, in some aspects, includes at least one of a physical sensor installed in a system or a virtual sensor derived from a set of physical sensors based on a physics-based model. For example, the sensor data may be received at sensor data module 110 from the plurality of related sensors, or may be received from the sensor data module 110 at another module of the solution architecture.

At 720, the method may identify, for a first sensor in the plurality of related sensors, a set of correlated sensors in the plurality of related sensors. The first sensor, in some aspects, is a first critical sensor, where a critical sensor is a sensor that captures critical data for monitoring a health of an underlying system and may be used for at least one of identifying a remediation strategy, deriving business insights, or building solutions for problems relating to a set of downstream tasks. The downstream tasks, in some aspect, may include one or more of anomaly detection, failure prediction, remaining useful life prediction. In some aspects, the set of correlated sensors includes a set of sensors with outputs correlated to an output of the first sensor. The set of correlated sensors, in some aspects, includes multiple sensors in the plurality of related sensors. For example, in some aspects, a correlation may be calculated between critical sensor data and the first principal component of multiple sensors data (or some other function of the multiple sensors data even when the individual sensors data may not be correlated at a threshold level). As indicated by the expanded view of 720, to identify the set of correlated sensors in the plurality of related sensors at 720, in some aspects, the method may further calculate, at 720A, a similarity score between the sensor data from the first sensor and sensor data from sensors in the plurality of related sensors and may, based on the similarity score between the sensor data from the first sensor and sensor data from the set of correlated sensors being above a threshold similarity score, identify, at 720B, the set of correlated sensors.

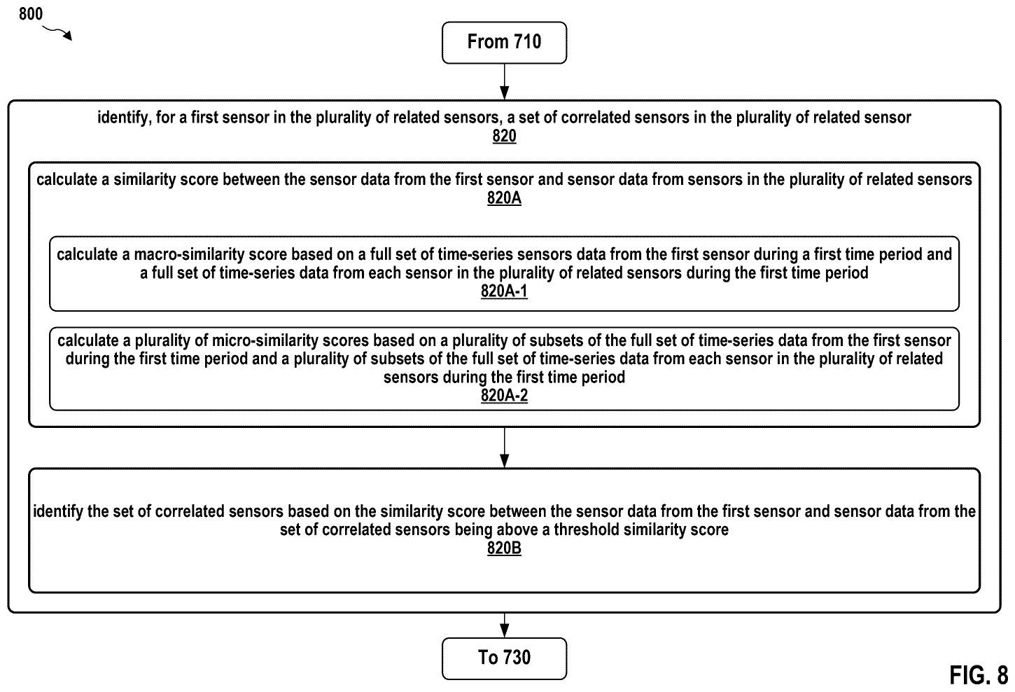

FIG. 8 is a diagram 800 further expanding the view of the sub-operations performed to identify the set of correlated sensors in the plurality of related sensors at 720 in some aspects. Elements 820, 820A, and 820B of FIG. 8, in some aspects, may correspond to elements 720, 720A, and 720B of FIG. 7 and further identify sub-operations associated with calculating a similarity score at 720A/820A. At 820A-1, the method may calculate a macro-similarity score based on a full set of time-series sensors data from the first sensor during a first time period and a full set of time-series data from each sensor in the plurality of related sensors during the first time period. Additionally, at 820A-2, the method may calculate a plurality of micro-similarity scores based on a plurality of subsets of the full set of time-series data from the first sensor during the first time period and a plurality of subsets of the full set of time-series data from each sensor in the plurality of related sensors during the first time period. As described above in relation to FIGS. 2A-3B, the calculations may be “standard” as in 2A and 3A, or may be “bootstrapped” as in 2B and 3B.

At 720B/820B, the method may identify the set of correlated sensors based on the similarity score between the sensor data from the first sensor and sensor data from the set of correlated sensors being above a threshold similarity score. The set of correlated sensors may then be identified as a set of one or more “substitute” sensors for the critical sensor in the event of sensor failure. For example, 720 may be performed by fault tolerance identification module 130.

At 730, the method may detect a fault in the first sensor based on at least one of the sensor data received from the sensor, the sensor data received from the set of correlated sensors, and the sensor data received from other sensors. The fault detection at 730 may be performed by fault detection module 140 or fault prediction module 150. In some aspects, detecting the fault in the sensor based on at least one of the sensor data received from the sensor, the sensor data received from the set of correlated sensors, and the sensor data received from other sensors at 730 includes using, at 730A, one or more of the following models to detect the fault in the sensor (1) a univariate anomaly detection model based on the sensor data received from the first sensor, (2) a bivariate anomaly detection model based on the sensor data received from the first sensor and the sensor data received from the set of correlated sensor, and/or (3) a multivariate anomaly detection model based on the sensor data received from all the sensors including the first sensor, the sensor data received from the set of correlated sensors, and the other sensors in the system. In some aspects, the method may additionally, use, at 730B, one or more of the following ensemble models to detect the fault in the sensor at 730, (1) an ensemble anomaly detection model based on the univariate anomaly detection model and the bivariate anomaly detection model or (2) an ensemble anomaly detection model based on the univariate anomaly detection model and the multivariate anomaly detection model.

In aspects detecting a real-time fault in the first sensor, a univariate (anomaly) score, a bivariate (anomaly) score, and/or a multivariate (anomaly) score may be calculated, at 730A, based on the univariate anomaly detection model, the bivariate anomaly detection model, and/or the multivariate anomaly detection model respectively. An ensemble (anomaly) score, in some aspects, may be calculated at 730B based on one or both of (1) the ensemble anomaly detection model based on the univariate anomaly scores and the bivariate anomaly scores and/or (2) the ensemble anomaly detection model based on the univariate anomaly scores and the multivariate anomaly scores. In some aspects, detecting the fault in the first sensor at 730 includes detecting a predicted fault of the first sensor. Detecting the predicted fault of the first sensor, in some aspects, may be based on a sequence prediction model based on deep learning RNN as discussed above. In some aspects, the sequence prediction model may be one of a LSTM or GRU model. As part of detecting a predicted fault in the first sensor at 730, the method may, at 730A, calculate (or predict) multiple predicted anomaly scores including at least two of a univariate anomaly score, a bivariate anomaly score, or a multivariate anomaly score based on a prediction model (e.g., the sequence prediction model discussed above). The method may further calculate, at 730B, a predicted fault score indicating a likelihood of the sensor fault by generating an ensemble of anomaly scores based on the multiple anomaly scores calculated at 730A and one or both of (1) the ensemble anomaly detection (prediction) model based on the univariate anomaly scores and the bivariate anomaly scores and/or (2) the ensemble anomaly detection (prediction) model based on the univariate anomaly scores and the multivariate anomaly scores. For example, 730, 730A, and 730B, may be performed by fault prediction module 150.

Finally, at 740, the method may implement (e.g., activate, suggest for a user to implement, and so on) a remediation strategy based on the detected, at 730, fault of the first sensor. For example, 740 may be performed by fault remediation and fault tolerance module 160. The remediation strategy, in some aspects, includes using sensor data from one or more sensors in the set of correlated sensors to replace the sensor data from the first sensor. In some aspects, the remediation strategy is based on a root cause analysis of the detected fault based on one or more explainable artificial intelligence (AI) techniques (e.g., ELI5 or SHAP). Given a prediction result from a machine learning model, explainable AI technique can discover the contribution of each feature (used in the machine learning model) to the prediction result. The contribution is measured by a weight value which the operator and/or technician can use to figure out the root cause of the prediction result. The sensor data from the one or more sensors in the set of correlated sensors is determined based on one or more of the following criteria (1) a calculated similarity score between the sensor data from the first sensor and sensor data from sensors in the set of related sensors, (2) the geolocation of the first sensor and sensors in the set of related sensors, and/or (3) the time sequence of the first sensor and sensors in the set of related sensors.

As described above, this disclosure introduces several data-driven approaches to automatically detect, predict and remediate faults in sensors in real time. Fault detection, prediction, remediation, and tolerance are provided as needed (e.g., a just in time model) that avoids unnecessary inspection and can be applied in real-time to a set of critical sensors while avoiding unnecessary monitoring or maintenance of non-critical sensors. Both physical sensors and/or virtual sensors (from digital twin models) are incorporated into this solution framework, where virtual sensors, in some aspects, offer fault tolerance to the physical sensors. The disclosure allows an operator or technician to distinguish faults in sensors versus system components. Additionally, fault tolerance from already installed similar sensors is identified and utilized to reduce cost to install new sensors to enable fault tolerance or the costs associated with the failure of a critical sensor. Furthermore, faults in sensors can be predicted which allows the remediation to be performed or scheduled for more convenient, or less costly, times (e.g., before incurring costs associated with a sensor failure). The analysis may also be used to proactively introduce systematic fault tolerance are presented before any faults are detected.

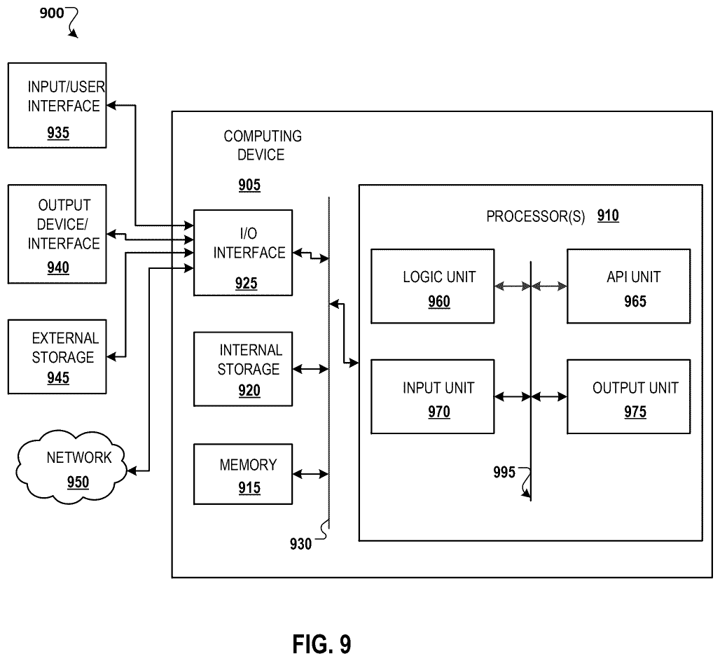

FIG. 9 illustrates an example computing environment with an example computer device suitable for use in some example implementations. Computer device 905 in computing environment 900 can include one or more processing units, cores, or processors 910, memory 915 (e.g., RAM, ROM, and/or the like), internal storage 920 (e.g., magnetic, optical, solid-state storage, and/or organic), and/or IO interface 925, any of which can be coupled on a communication mechanism or bus 930 for communicating information or embedded in the computer device 905. IO interface 925 is also configured to receive images from cameras or provide images to projectors or displays, depending on the desired implementation.

Computer device 905 can be communicatively coupled to input/user interface 935 and output device/interface 940. Either one or both of the input/user interface 935 and output device/interface 940 can be a wired or wireless interface and can be detachable. Input/user interface 935 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 940 may include a display, television, monitor, printer, speaker, braille, or the like. In some example implementations, input/user interface 935 and output device/interface 940 can be embedded with or physically coupled to the computer device 905. In other example implementations, other computer devices may function as or provide the functions of input/user interface 935 and output device/interface 940 for a computer device 905.

Examples of computer device 905 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 905 can be communicatively coupled (e.g., via IO interface 925) to external storage 945 and network 950 for communicating with any number of networked components, devices, and systems, including one or more computer devices of the same or different configuration. Computer device 905 or any connected computer device can be functioning as, providing services of, or referred to as a server, client, thin server, general machine, special-purpose machine, or another label.

IO interface 925 can include but is not limited to, wired and/or wireless interfaces using any communication or IO protocols or standards (e.g., Ethernet, 902.11x, Universal System Bus, WiMax, modem, a cellular network protocol, and the like) for communicating information to and/or from at least all the connected components, devices, and network in computing environment 900. Network 950 can be any network or combination of networks (e.g., the Internet, local area network, wide area network, a telephonic network, a cellular network, satellite network, and the like).

Computer device 905 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 905 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 910 can execute under any operating system (OS) (not shown), in a native or virtual environment. One or more applications can be deployed that include logic unit 960, application programming interface (API) unit 965, input unit 970, output unit 975, and inter-unit communication mechanism 995 for the different units to communicate with each other, with the OS, and with other applications (not shown). The described units and elements can be varied in design, function, configuration, or implementation and are not limited to the descriptions provided. Processor(s) 910 can be in the form of hardware processors such as central processing units (CPUs) or in a combination of hardware and software units.

In some example implementations, when information or an execution instruction is received by API unit 965, it may be communicated to one or more other units (e.g., logic unit 960, input unit 970, output unit 975). In some instances, logic unit 960 may be configured to control the information flow among the units and direct the services provided by API unit 965, the input unit 970, the output unit 975, in some example implementations described above. For example, the flow of one or more processes or implementations may be controlled by logic unit 960 alone or in conjunction with API unit 965. The input unit 970 may be configured to obtain input for the calculations described in the example implementations, and the output unit 975 may be configured to provide an output based on the calculations described in example implementations.

Processor(s) 910 can be configured to receive sensor data from a plurality of related sensors. The processor(s) 910 may also be configured to identify, for a first sensor in the plurality of related sensors, a set of correlated sensors in the plurality of related sensors. The processor(s) 910 may further be configured to detect a fault in the first sensor based on at least one of the sensor data received from the sensor, the sensor data received from the set of correlated sensors, and the sensor data received from other sensors. The processor(s) 910 may further be configured to implement a remediation strategy based on the detected fault of the first sensor. The processor(s) 910 may further be configured to calculate a similarity score between the sensor data from the first sensor and sensor data from sensors in the plurality of related sensors. The processor(s) 910 may also be configured to identify the set of correlated sensors based on the similarity score between the sensor data from the first sensor and sensor data from the set of correlated sensors being above a threshold similarity score. The processor(s) 910 may also be configured to calculate a macro-similarity score based on a full set of time-series sensors data from the first sensor during a first time period and a full set of time-series data from each sensor in the plurality of related sensors during the first time period. The processor(s) 910 may also be configured to calculate a plurality of micro-similarity scores based on a plurality of subsets of the full set of time-series data from the first sensor during the first time period and a plurality of subsets of the full set of time-series data from each sensor in the plurality of related sensors during the first time period. The processor(s) 910 may also be configured to calculate (or predict) multiple anomaly scores including at least two of a univariate anomaly score, a bivariate anomaly score, or a multivariate anomaly score. The processor(s) 910 may also be configured to a predicted fault score indicating a likelihood of the sensor fault by generating an ensemble of anomaly scores based on the multiple anomaly scores.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed:

1. A method comprising:
receiving sensor data from a plurality of related sensors;
identifying, for a first sensor in the plurality of related sensors, a set of correlated sensors in the plurality of related sensors;
detecting a fault in the first sensor based on at least one of the sensor data received from the sensor, the sensor data received from the set of correlated sensors, and the sensor data received from other sensors; and
implementing a remediation strategy based on the detected fault of the first sensor.

2. The method of claim 1, wherein detecting the fault in the first sensor comprises detecting a predicted fault of the first sensor and detecting the predicted fault of the first sensor is based on a sequence prediction model based on deep learning recurrent neural network, the sequence prediction model comprising:
predicting multiple anomaly scores including at least two of a univariate anomaly score, a bivariate anomaly score, or a multivariate anomaly score; and
calculating a predicted fault score indicating a likelihood of the sensor fault by generating an ensemble of anomaly scores based on the multiple anomaly scores.

3. The method of claim 1, wherein the plurality of related sensors are sensors monitoring a same system.

4. The method of claim 1, wherein the plurality of related sensors comprises at least one of a physical sensor installed in a system or a virtual sensor derived from a set of physical sensors based on a physics-based models.

5. The method of claim 1, wherein the first sensor is a first critical sensor, wherein a critical sensor is a sensor that captures critical data for monitoring a health of an underlying system and is used for at least one of identifying the remediation strategy, deriving business insights, or building solutions for problems relating to a set of downstream tasks.

6. The method of claim 1, wherein the set of correlated sensors comprises a set of sensors with outputs correlated to an output of the first sensor.

7. The method of claim 1, wherein the set of correlated sensors comprises multiple sensors in the plurality of related sensors, wherein an output of at least one sensor of the multiple sensors is not correlated to the output of the first sensor with a threshold correlation and identifying the set of correlated sensors is based on a function of the outputs of the multiple sensors being correlated to the first sensor with the threshold correlation.

8. The method of claim 1, wherein identifying the set of correlated sensors comprises:
calculating a similarity score between the sensor data from the first sensor and sensor data from sensors in the plurality of related sensors; and
identifying the set of correlated sensors based on the similarity score between the sensor data from the first sensor and sensor data from the set of correlated sensors being above a threshold similarity score.

9. The method of claim 8, wherein calculating the similarity score between the sensor data from the first sensor and sensor data from sensors in the plurality of related sensors comprises at least one of:
calculating a macro-similarity score based on a full set of time-series sensors data from the first sensor during a first time period and a full set of time-series data from each sensor in the plurality of related sensors during the first time period; or
calculating a plurality of micro-similarity scores based on a plurality of subsets of the full set of time-series data from the first sensor during the first time period and a plurality of subsets of the full set of time-series data from each sensor in the plurality of related sensors during the first time period.

10. The method of claim 1, wherein detecting the fault in the sensor based on at least one of the sensor data received from the sensor, the sensor data received from the set of correlated sensors, and the sensor data received from other sensors comprises one or more models to detect the fault in the sensor, the one or models comprising:
a univariate anomaly detection model based on the sensor data received from the first sensor;
a bivariate anomaly detection model based on the sensor data received from the first sensor and the sensor data received from the set of correlated sensors; or
a multivariate anomaly detection model based on the sensor data received from the plurality of related sensors including the sensor data received from the first sensor, the sensor data received from the set of correlated sensors, and the sensor data received from other sensors.

11. The method of claim 10 further comprising using one or more ensemble models to detect the fault in the sensor, the one or more ensemble models comprising:
an ensemble anomaly detection model based on the univariate anomaly detection model and the bivariate anomaly detection model; or
an ensemble anomaly detection model based on the univariate anomaly detection model and the multivariate anomaly detection model.

12. The method of claim 1, wherein the remediation strategy comprises using sensor data from one or more sensors in the set of correlated sensors to replace the sensor data from the first sensor.

13. The method of claim 12, wherein the remediation strategy is based on a root cause analysis of the detected fault based on one or more explainable artificial intelligence (AI) techniques.

14. The method of claim 12, wherein the sensor data from the one or more sensors in the set of correlated sensors is determined based on one or more of:
a calculated similarity score between the sensor data from the first sensor and the sensor data from the sensors in the set of related sensors;
a geolocation of the first sensor and the sensors in the set of related sensors; or
a time sequence of the first sensor and the sensors in the set of related sensors.

15. An apparatus comprising:
a memory; and
at least one processor coupled to the memory and, based at least in part on information stored in the memory, the at least one processor is configured to:
receive sensor data from a plurality of related sensors;
identify, for a first sensor in the plurality of related sensors, a set of correlated sensors in the plurality of related sensors;
detect a fault in the first sensor based on at least one of the sensor data received from the sensor, the sensor data received from the set of correlated sensors, and the sensor data received from other sensors; and
implement a remediation strategy based on the detected fault of the first sensor.

16. The apparatus of claim 15, wherein the at least one processor is configured to identify the set of correlated sensors by:
calculating a similarity score between the sensor data from the first sensor and sensor data from sensors in the plurality of related sensors by one of:
calculating a macro-similarity score based on a full set of time-series sensors data from the first sensor during a first time period and a full set of time-series data from each sensor in the plurality of related sensors during the first time period; or
calculating a plurality of micro-similarity scores based on a plurality of subsets of the full set of time-series data from the first sensor during the first time period and a plurality of subsets of the full set of time-series data from each sensor in the plurality of related sensors during the first time period; and
identifying the set of correlated sensors based on the similarity score between the sensor data from the first sensor and sensor data from the set of correlated sensors being above a threshold similarity score.

17. The apparatus of claim 16, wherein the fault in the first sensor comprises a predicted fault of the first sensor and the at least one processor is configured to detect the predicted fault of the first sensor based on a sequence prediction model based on deep learning recurrent neural network, by:
predicting multiple anomaly scores including at least two of a univariate anomaly score, a bivariate anomaly score, or a multivariate anomaly score; and
calculating a predicted fault score indicating a likelihood of the sensor fault by generating an ensemble of anomaly scores based on the multiple anomaly scores.

18. A computer-readable medium storing computer executable code at an apparatus, the code when executed by a processor causes the processor to:
receive sensor data from a plurality of related sensors;
identify, for a first sensor in the plurality of related sensors, a set of correlated sensors in the plurality of related sensors;
detect a fault in the first sensor based on at least one of the sensor data received from the sensor, the sensor data received from the set of correlated sensors, and the sensor data received from other sensors; and
implement a remediation strategy based on the detected fault of the first sensor.

19. The computer-readable medium of claim 18, wherein the code when executed by the processor causes the processor to:
detect a fault in the sensor based on at least one of the sensor data received from the sensor, the sensor data received from the set of correlated sensors, and the sensor data received from other sensors using one or more models to detect the fault in the sensor, the one or models comprising:
a univariate anomaly detection model based on the sensor data received from the first sensor;
a bivariate anomaly detection model based on the sensor data received from the first sensor and the sensor data received from the set of correlated sensors;
a multivariate anomaly detection model based on the sensor data received from the plurality of related sensors including the sensor data received from the first sensor, the sensor data received from the set of correlated sensors, and the sensor data received from other sensors;
an ensemble anomaly detection model based on the univariate anomaly detection model and the bivariate anomaly detection model; or
an ensemble anomaly detection model based on the univariate anomaly detection model and the multivariate anomaly detection model.

20. The computer-readable medium of claim 18, wherein the fault in the first sensor comprises a predicted fault of the first sensor and the code when executed by the processor causes the processor to:
detect the predicted fault of the first sensor based on a sequence prediction model based on deep learning recurrent neural network, by:
predicting multiple anomaly scores including at least two of a univariate anomaly score, a bivariate anomaly score, or a multivariate anomaly score; and
calculating a predicted fault score indicating a likelihood of the sensor fault by generating an ensemble of anomaly scores based on the multiple anomaly scores.
